(19) United States
(12) Patent Application Publication
(10) Pub. No.: US 2024/0321279 A1
(43) Pub. Date: Sep. 26, 2024

(54) SYSTEM, APPARATUS, AND METHOD FOR USING A CHATBOT

(71) Applicant: Innovative Eyewear, Inc., Miami, FL (US)

(72) Inventors: Harrison Gross, North Miami, FL (US); Clifford Gross, Miami, FL (US)

(21) Appl. No.: 18/189,547

(22) Filed: Mar. 24, 2023

(51) Int. Cl. G10L 15/32; G06F 3/16; G06F 16/635; G06F 40/35; G10L 13/02; G10L 15/22; G10L 15/26; G10L 15/30; H04L 51/02

(52) U.S. Cl. CPC G10L 15/32; G06F 3/167; G06F 16/635; G06F 40/35; G10L 13/02; G10L 15/22; G10L 15/26; G10L 15/30; H04L 51/02

(57) ABSTRACT

A system configured to communicate with a chatbot application is disclosed. The system has at least one smart device, comprising a processor, the at least one smart device configured to communicate with the chatbot application that includes computer-executable code stored in non-volatile memory. The at least one smart device is configured to record a first audio data or signal associated with at least one voice query, and provide the first audio data or signal associated with the at least one voice query to the chatbot application, the chatbot application configured to convert the first audio data or signal to a first text data or signal associated with the at least one voice query. The chatbot application is configured to operate or communicate with a plurality of chatbots and to select at least one chatbot from the plurality of chatbots based on the first text data or signal.

### FIELD OF THE INVENTION

The present disclosure generally relates to a system, apparatus, and method for a chatbot, and more particularly to a system, apparatus, and method for using a chatbot.

### BACKGROUND OF THE INVENTION

Conventional chatbots having voice interfaces typically include relatively less advanced chatbots such as voice assistants. Many powerful chatbots typically lack voice interface functions. For example, many chatbots are text-based chatbots.

U.S. Pat. No. 11,445,301 to Park (the '301 patent) provides one attempt to overcome at least some of the above-mentioned limitations of the prior art. The '301 patent discloses connecting a playback device to a network to initiate a voice assistant for example of a mobile device.

However as best understood, the voice assistant of the '301 patent appears to serve as a chatbot. Therefore, the chatbot of the '301 patent appears to include voice interface functions. Accordingly, the '301 patent does not appear to disclose a system for providing a voice interface to one or more relatively powerful text-based chatbots that may lack voice interface functions.

Accordingly, a need in the art exists for an efficient and convenient technique for providing a voice interface function to one or more chatbots that lack a voice interface function. For example, a need in the art exists for providing a voice interface function to one or more relatively powerful text-based chatbots that lack a voice interface function.

The exemplary disclosed system and method are directed to overcoming one or more of the shortcomings set forth above and/or other deficiencies in existing technology.

### SUMMARY OF THE INVENTION

In one exemplary aspect, the present disclosure is directed to a system configured to communicate with a chatbot application. The system includes at least one smart device, comprising a processor, the at least one smart device configured to communicate with the chatbot application that includes computer-executable code stored in non-volatile memory. The at least one smart device is configured to record a first audio data or signal associated with at least one voice query, and provide the first audio data or signal associated with the at least one voice query to the chatbot application, the chatbot application configured to convert the first audio data or signal to a first text data or signal associated with the at least one voice query. The chatbot application is configured to operate or communicate with a plurality of chatbots and to select at least one chatbot from the plurality of chatbots based on the first text data or signal. The chatbot application is configured to generate a second text data or signal associated with a response to the at least one voice query based on operating or communicating with the at least one chatbot. The chatbot application is configured to convert the second text data or signal to a second voice data or signal associated with the response, and provide the second voice data or signal to the at least one smart device, and emit sound based on the second voice data or signal.

In another aspect, the present disclosure is directed to a method for using at least one smart device configured to communicate with a chatbot application. The method includes providing the at least one smart device, comprising a processor, configured to communicate with the chatbot application that includes computer-executable code stored in non-volatile memory, recording a first audio data or signal associated with at least one voice query, and providing the first audio data or signal associated with the at least one voice query to the chatbot application, the chatbot application configured to convert the first audio data or signal to a first text data or signal associated with the at least one voice query. The chatbot application is configured to operate or communicate with a plurality of chatbots and to select at least one chatbot from the plurality of chatbots based on the first text data or signal. The chatbot application is configured to generate a second text data or signal associated with a response to the at least one voice query based on operating or communicating with the at least one chatbot. The chatbot application is configured to convert the second text data or signal to a second voice data or signal associated with the response, and provide the second voice data or signal to the at least one smart device. The method also includes emitting sound based on the second voice data or signal.

### BRIEF DESCRIPTION OF THE DRAWINGS

FIG. 1 is a schematic illustration of an exemplary system of the present invention;

FIG. 2 is a schematic illustration of an exemplary system of the present invention;

FIG. 3 is a schematic illustration of an exemplary system of the present invention;

FIG. 4 is a schematic illustration of an exemplary data flow of the present invention;

FIG. 5 is a schematic illustration of an exemplary graphical user interface of the present invention;

FIG. 6 is a schematic illustration of an exemplary graphical user interface of the present invention;

FIG. 7 is a schematic illustration of exemplary graphical elements of the present invention;

FIG. 8 is a schematic illustration of an exemplary graphical user interface of the present invention;

FIG. 9 is a schematic illustration of an exemplary graphical user interface of the present invention;

FIG. 10 is a schematic illustration of an exemplary graphical element of the present invention;

FIG. 11 is a flowchart showing an exemplary process of the present invention;

FIG. 12 is a schematic illustration of an exemplary computing device, in accordance with at least some exemplary embodiments of the present disclosure; and

FIG. 13 is a schematic illustration of an exemplary network, in accordance with at least some exemplary embodiments of the present disclosure.

### DETAILED DESCRIPTION AND INDUSTRIAL APPLICABILITY

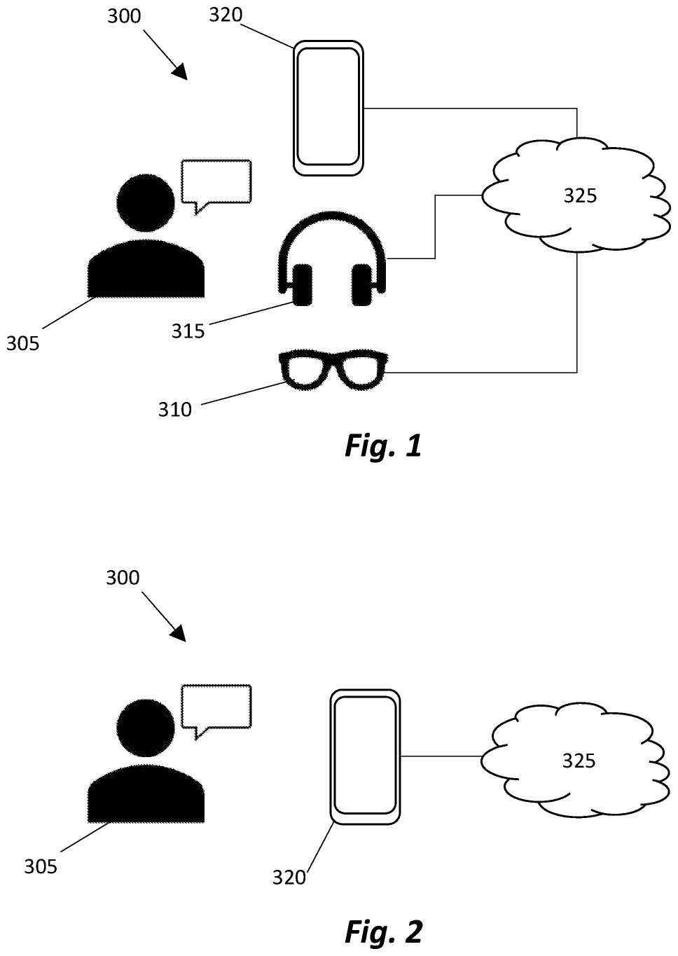

FIG. 1 illustrates an exemplary embodiment of a system 300 for using a chatbot. In at least some exemplary embodiments, system 300 may be a system for using and controlling a chatbot using voice commands and/or any other suitable sounds. A user may utilize any suitable device for receiving voice and/or sound such as, for example, user devices such as phones, tablets, or computing devices, electronic devices such as headphones or any other suitable consumer electronics, glasses or other suitable devices that may include electronics for receiving voice and/or sound, and/or any other desired devices.

As illustrated in FIG. 1, system 300 may include one or more devices (e.g., smart devices) such as glasses 310, headphones 315, and a user device 320 that may receive voice commands or other suitable sounds for example from a user 305 (e.g., and/or any other desired device). Glasses 310, headphones 315, and user device 320 may be connected to a network 325 and utilized (e.g., and/or worn or carried) by user 305. Glasses 310, headphones 315, and/or user device 320 may also be directly connected to each other. Data such as audio data, text data, image data, and/or control data may be transferred between glasses 310, headphones 315, user device 320, and/or network 325.

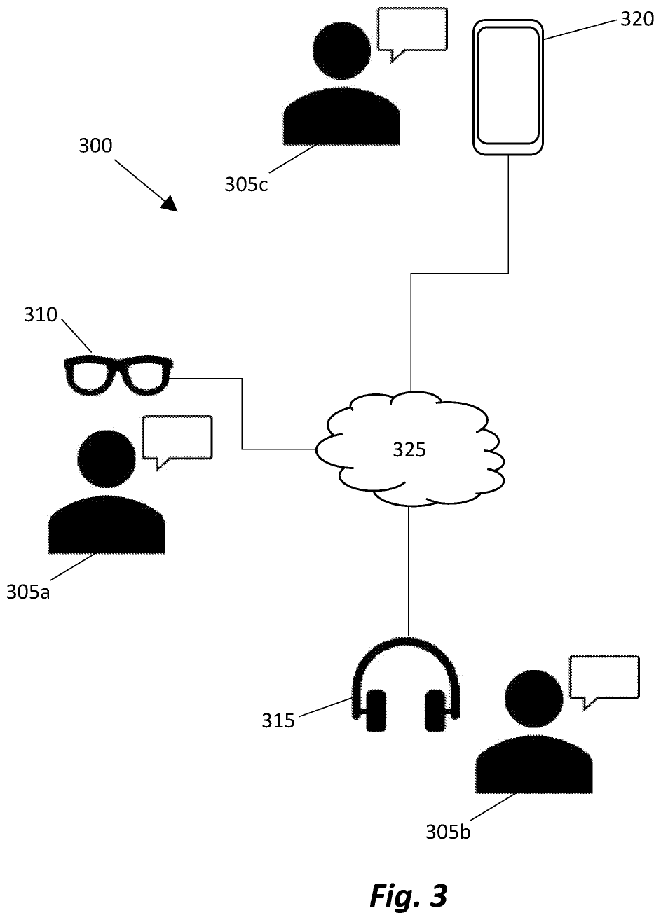

FIG. 2 illustrates another exemplary embodiment of system 300. As illustrated in FIG. 2, system 300 may include user device 320 that may be connected to network 325. User device 320 may receive voice and/or sound commands from user 305 and/or any other desired source.

FIG. 3 illustrates another exemplary embodiment of system 300. As illustrated in FIG. 3, system 300 may include glasses 310, headphones 315, and user device 320 that may be connected to network 325 and/or directly to each other. Glasses 310 may receive voice and/or sound commands from a user 305a and/or any other desired source. Headphones 315 may receive voice and/or sound commands from a user 305b and/or any other desired source. User device 320 may receive voice and/or sound commands from a user 305c and/or any other desired source.

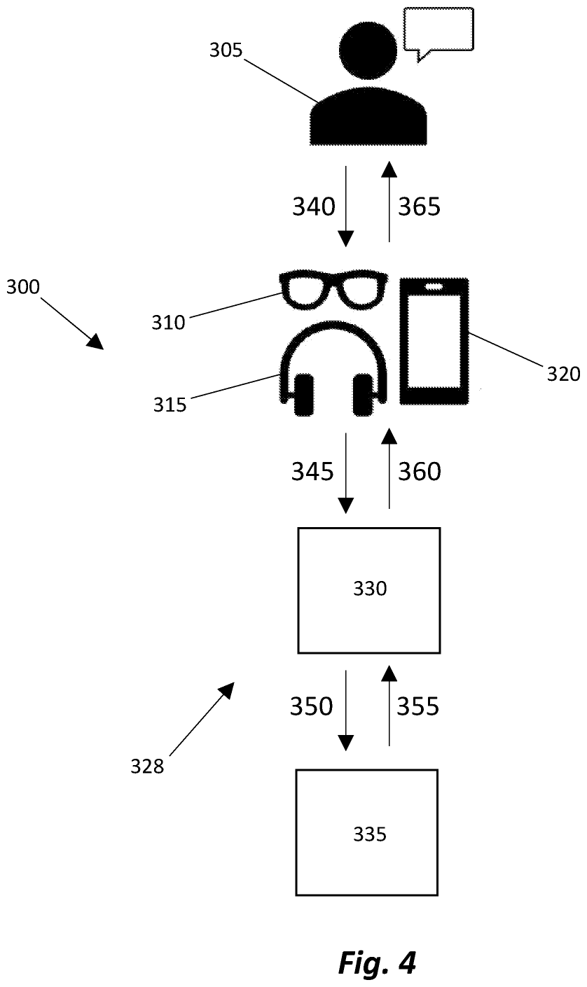

As illustrated in FIG. 4, system 300 may include a chatbot application 328 comprising an audio assistant 330 and a chatbot platform 335. For example, chatbot application 328 may include the exemplary disclosed module described below, audio assistant 330, and/or chatbot platform 335. Audio assistant 330 and/or chatbot platform 335 may be fully or partially integrated into glasses 310, headphones 315, user device 320, and/or network 325 (e.g., and/or a platform connected to network 325). In at least some exemplary embodiments, audio assistant 330 may be integrated into glasses 310, headphones 315, and/or user device 320, and chatbot platform 335 may be integrated into one or more of glasses 310, headphones 315, user device 320, and/or network 325 (e.g., and/or a platform connected to network 325).

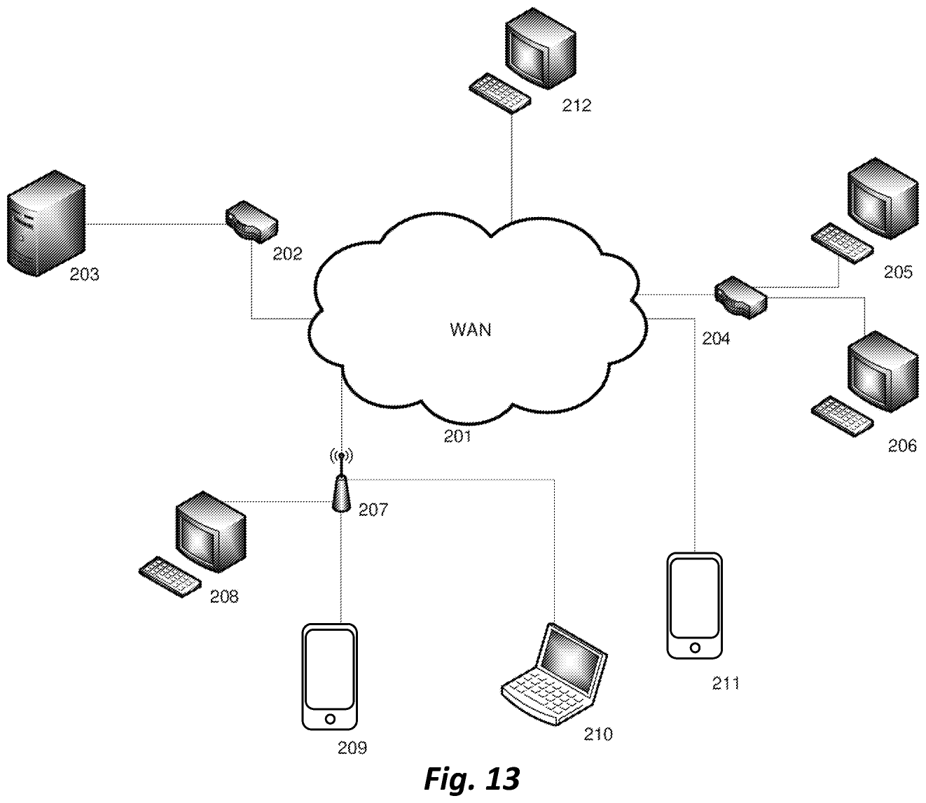

Glasses 310, headphones 315, user device 320, and/or network 325 (e.g., including partially or substantially entirely integrated audio assistant 330 and/or chatbot platform 335) may communicate via any suitable communication technique. Network 325 may be any suitable communication network over which data may be transferred between one or more glasses 310, headphones 315, and/or user device 320. Network 325 may be the internet, a LAN (e.g., via Ethernet LAN), a WAN, a WiFi network, or any other suitable network. Network 325 may be similar to WAN 201 described below. The components of system 300 may also be directly connected (e.g., by wire, cable, USB connection, and/or any other suitable electro-mechanical connection) to each other and/or connected via network 325. For example, components of system 300 may wirelessly transmit data by any suitable technique such as, e.g., wirelessly transmitting data via 4G LTE networks (e.g., or 5G networks) or any other suitable data transmission technique for example via network communication. Components of system 300 may transfer data via the exemplary techniques described below regarding FIG. 13. Glasses 310, headphones 315, and/or user device 320 may include integrally formed communication devices that may communicate using any of the exemplary disclosed communication techniques. Glasses 310, headphones 315, user device 320, and/or network 325 may communicate via Wifi, Bluetooth, ZigBee, NFC, IrDA, and/or any other suitable short distance technique.

As illustrated in FIG. 4, voice and/or sound of user 305 and/or any other suitable sound may be transferred to and received by the exemplary disclosed device (e.g., glasses 310, headphones 315, and/or user device 320) as shown at 340. For example, user 305 may provide a voice (e.g., speech) query at 340. Audio or sound data and/or signals (e.g., of the speech or voice query provided at 340) may be transferred via the exemplary disclosed communication techniques from the exemplary disclosed device (e.g., glasses 310, headphones 315, and/or user device 320) to audio assistant 330 as shown at 345. Audio assistant 330 may convert the audio or sound data and/or signals to text data and/or signals. The text data and/or signals may be transferred via the exemplary disclosed communication techniques from audio assistant 330 to chatbot platform 335 as shown at 350. Text data and/or signals may be transferred via the exemplary disclosed communication techniques from chatbot platform 335 to audio assistant 330 as shown at 355. Audio assistant 330 may convert the text data and/or signals to audio or sound data and/or signals. The audio or sound data and/or signals may be transferred via the exemplary disclosed communication techniques from audio assistant 330 to the exemplary disclosed device (e.g., glasses 310, headphones 315, and/or user device 320) as shown at 360. Sound (e.g., computer voice) and/or any other suitable sound may be emitted or played by the exemplary disclosed device (e.g., glasses 310, headphones 315, and/or user device 320) and heard by user 305 as shown at 365 (e.g., a voice or speech response to the voice or speech query provided at 340).

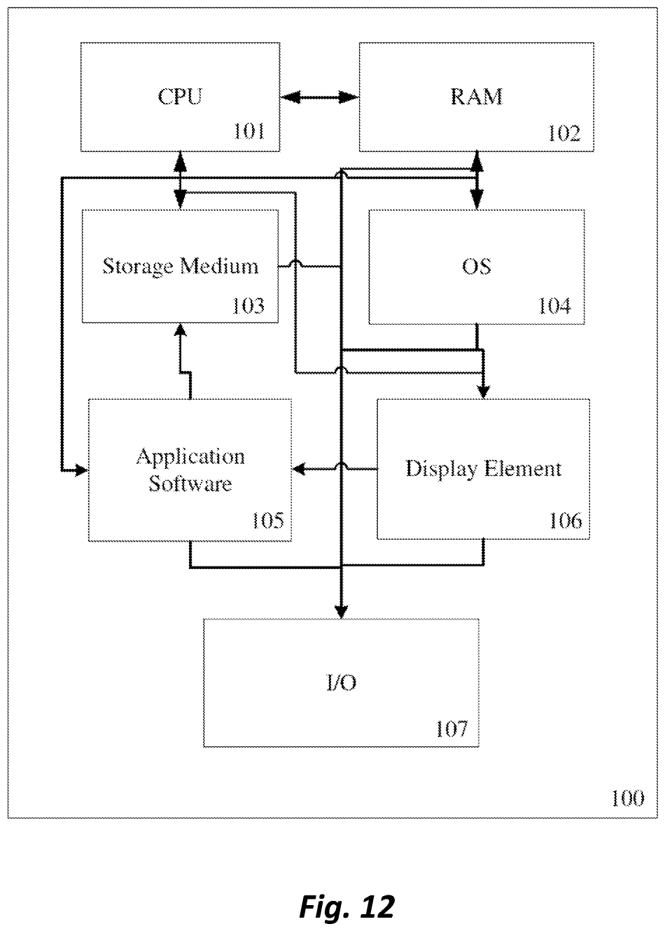

User device 320 may be any suitable device for interfacing with other components of system 300 such as a computing device (e.g., user interface). For example, user device 320 may be any suitable user interface for receiving input and/or providing output (e.g., audio, text, and/or image data) to a user (e.g., user 305 and/or users 305a, 305b, and/or 305c). User device 320 may include a camera and a microphone (e.g., and/or a speaker) for receiving, recording, emitting, and/or playing sound. For example, user device 320 may include a microphone and/or a speaker for receiving a voice (e.g., speech) query at 340 and emitting a sound response (e.g., voice or speech response) at 365. User device 320 may be, for example, a touchscreen device (e.g., of a smartphone, a tablet, a smartboard, and/or any suitable computer device), a wearable device (e.g., a wearable smart device such as a smartwatch or smart fitness device), a computer keyboard and monitor (e.g., desktop or laptop), an audio-based device for entering input and/or receiving output via sound, a tactile-based device for entering input and receiving output based on touch or feel, a dedicated user interface designed to work specifically with other components of system 300, and/or any other suitable user interface (e.g., including components and/or configured to work with components described below regarding FIGS. 12 and 13). For example, user device 320 may include a touchscreen device of a smartphone or handheld tablet. For example, user device 320 may include a display (e.g., a computing device display, a touchscreen display, and/or any other suitable type of display) that may provide output, image data, and/or any other desired output or input prompt to a user. For example, the exemplary display may include a graphical user interface to facilitate entry of input by a user and/or receiving output such as image data. An application for example as described herein and/or a web browser may be installed on user device 320 and utilized by a user (e.g., user 305 and/or users 305a, 305b, and/or 305c). User device 320 may include a sensor array including one or more sensors integrated or built into the exemplary disclosed user device. User device 320 may include any suitable sensors for use with system 300 such as, for example, a location sensor (e.g., a GPS device, a Galileo device, a GLONASS device, an IRNSS device, a BeiDou device, and/or any other suitable device that may operate with a global navigation system) and/or a movement sensor (e.g., an accelerometer, a gyroscope, and/or any other suitable sensors).

System 300 may include one or modules (e.g., chatbot modules) for performing the exemplary disclosed operations. The one or more modules may be a part of (e.g., fully or partially integrated into) chatbot application 328. The one or more modules may include a control module (e.g., a chatbot control module) for controlling an operation of glasses 310, headphones 315, user device 320, audio assistant 330, and/or chatbot platform 335. The one or more modules may be stored and operated by any suitable components of system 300 (e.g., including processor components) such as, for example, glasses 310, headphones 315, user device 320, network 325, and/or any other suitable component of system 300. For example, system 300 may include one or more modules having computer-executable code stored in non-volatile memory. System 300 may also include one or more storages (e.g., buffer storages) that may include components similar to the exemplary disclosed computing device and network components described below regarding FIGS. 12 and 13. For example, the exemplary disclosed buffer storage may include components similar to the exemplary storage medium and RAM described below regarding FIG. 12. The exemplary disclosed buffer storage may be implemented in software and/or a fixed memory location in hardware of system 300. The exemplary disclosed buffer storage (e.g., a data buffer) may store data temporarily during an operation of system 300. The one or more modules may operate utilizing artificial intelligence and machine learning operations for example as described herein.

Headphones 315 may be any suitable type of headphones such as, for example, over-ear headphones, on-ear headphones, closed-back headphones, open-back headphones, in-car headphones, earbuds, noise-canceling headphones, Bluetooth headphones, bone-conducting headphones, headsets, ambient sound headphones, and/or any other desired type of audio device. Headphones 315 may be smart headphones that may communicate with the other exemplary disclosed components of system 300 via the exemplary disclosed communication techniques. Headphones 315 may include a microphone and/or a speaker for receiving, recording, emitting, and/or playing sound. For example, headphones 315 may include a microphone and/or a speaker for receiving a voice (e.g., speech) query at 340 and emitting a sound (e.g., voice or speech) response at 365.

Glasses 310 may be any suitable type of glasses such as, for example, full-rimmed, semi-rimless, rimless, wire, or low-bridge glasses. Glasses 310 may be smart glasses that may communicate with the other exemplary disclosed components of system 300 via the exemplary disclosed communication techniques. Glasses 310 may include a microphone and/or a speaker for receiving, recording, emitting, and/or playing sound. For example, glasses 310 may include a microphone and/or a speaker for receiving a speech or voice query at 340 and emitting a sound (e.g., voice or speech) response at 365. In at least some exemplary embodiments, the microphone (e.g., and/or a speaker) and an AI interface of glasses 310 may receive an oral request or command audibly proceeded by language by user 305 (e.g., such as “tell me” or “show me,”) that may be communicated to the AI interface of glasses 310. In at least some exemplary embodiments, glasses 310 may be smart glasses including a microphone, a speaker (e.g., such as bone conduction speakers and/or any other suitable speakers), an AI interface, a battery, and/or a controller (e.g., a circuit board). Headphones 315 and/or user device 320 may include similar components. Glasses 310 may include any suitable projector, waveguide, and/or lenses that may selectively display the exemplary disclosed text data and/or image data to user 305 wearing glasses 310. For example, glasses 310 may be smart glasses configured to operate using augmented reality to display text and images to user 305 wearing glasses 310 (e.g., during the exemplary disclosed process described below).

Audio assistant 330 may be any suitable intelligent personal assistant or intelligent virtual assistant. Audio assistant 330 may be any suitable software and/or hardware agent or application for converting audio or sound data and/or signals (e.g., at 345) to text data and/or signals (e.g., at 350) and/or for converting text data and/or signals (e.g., at 355) to audio or sound data and/or signals (e.g., at 360). Audio assistant 330 may include software and/or hardware that may be integrated into glasses 310, headphones 315, and/or user device 320 (e.g., and/or network 325 and/or a platform connected to network 325). Audio assistant 330 may be a voice user interface that operates using natural language generation, text-to-speech, automatic speech recognition, natural language processing, natural language understanding, speech-to-text, and/or any other suitable processes and/or engines. In at least some exemplary embodiments, audio assistant 330 may include Siri® (of Apple Inc.), Alexa® (of Amazon), Google Assistant® (of Google), Bixby® (of Samsung Electronics Co., Ltd.), Cortana® (of Microsoft Corporation), and/or any other suitable voice user interface.

Chatbot platform 335 may be an AI-powered contextual chatbot platform that may utilize machine learning and/or artificial intelligence for example as described herein. Chatbot platform 335 may utilize natural language processing, pattern matching, sequence to sequence models, recurrent neural networks, Naïve Bayes, long short term memory, and/or any other suitable processing, artificial intelligence types, and/or types of machine learning operations. Chatbot platform 335 (e.g., chatbot application 328 including chatbot platform 335) may communicate with and/or include one or more text-based or text-only content generators such as chatbots (e.g., or a voice-based and text-based chatbot). Chatbot 335 may communicate with and/or include any suitable type of content generator such as any suitable AI-powered content generators. Chatbot platform 335 may utilize large language models. Chatbot platform 335 may be fine-tuned using reinforcement learning, transfer learning, proximal policy optimization, and/or supervised learning. Chatbot platform 335 may communicate with and/or include one or more (e.g., a plurality of) chatbots. For example, chatbot platform 335 may communicate with and/or include a ChatGPT® (of OpenAI, L.P.) chatbot, a Chatsonic chatbot (of Writesonic), Jasper Chat (of Jasper), Bard AI (of Google), LaMDA (of Google), Socratic (of Google), Bing AI(R) (of Microsoft), DialoGPT (of Microsoft), Megatron-Turing NLG (of NVIDIA and Microsoft), Tabnine, and/or any other suitable chatbots. For example as described herein, system 300 may operate to select, prioritize, combine, integrate, and/or utilize data of any desired number of any desired types of chatbots.

The exemplary disclosed system, apparatus, and method may be used in any suitable application using a chatbot. The exemplary disclosed system, apparatus, and method may be used in any suitable application for providing a voice interface for a chatbot. For example, the exemplary disclosed system, apparatus, and method may be used in any suitable application for providing a voice interface for a text-based chatbot lacking a voice interface.

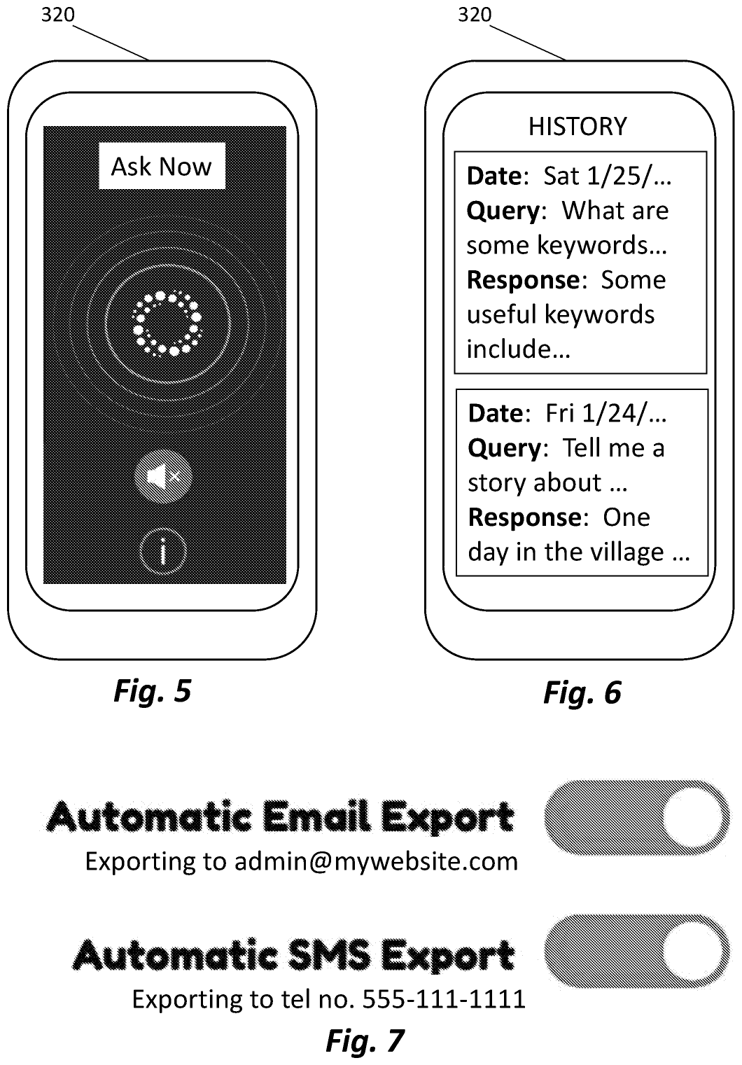

FIGS. 5-10 illustrate an exemplary disclosed graphical user interface (GUI) of system 300 that may be displayed using the exemplary disclosed user device (e.g., user device 320). In at least some exemplary embodiments and for example as illustrated in FIGS. 5-10, the exemplary disclosed GUI may include any suitable graphical elements for displaying data, settings, and/or output and/or receiving input from a user.

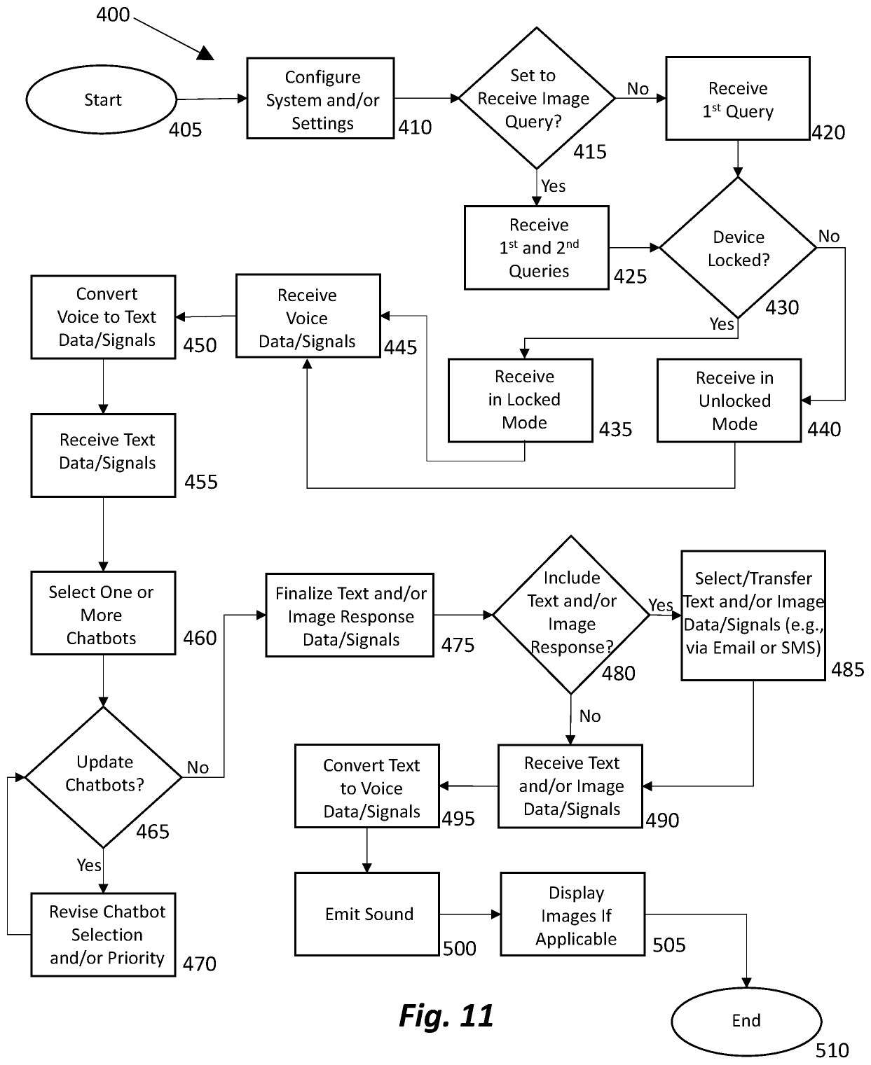

An exemplary operation of the exemplary disclosed system, apparatus, and method will now be described. FIG. 11 illustrates an exemplary process 400 of system 300. Process 400 begins at step 405.

At step 410, system 300 may be configured and/or re-configured. For example, system 300 may be configured as illustrated in FIGS. 1-4 or with any other suitable configuration. Any desired number and arrangement of glasses 310, headphones 315, user devices 320, audio assistants 330, chatbot platforms 335, and/or any other desired devices may be included in the configuration of system 300. A user (e.g., user 305) may input any desired setting and/or options for system 300 to the exemplary disclosed modules via the exemplary disclosed devices for example as described herein. The exemplary disclosed module, storage (e.g., storage buffer), and/or hardware may include a memory having stored thereon instructions, a processor configured to execute the instructions resulting in a software application, and a software application configured to perform process 400. For example, a user may input data and settings to configure system 300 for example via manipulation of the exemplary disclosed graphical elements illustrated in FIGS. 5, 7, 8, and 10. Also for example, a user may provide email, SMS phone number, and/or any other suitable contact information to be used by system 300 for example as described herein.

In at least some exemplary embodiments at step 410, a user may install an application of system 300 on user device 320 (e.g., and/or glasses 310 and/or headphones 315). The user may authorize the exemplary disclosed modules (e.g., application) to access and control functions of user device 320, glasses 310, and/or headphones 315. System 300 may be configured based on, for example, input provided by a user, a predetermined operation or algorithm of the exemplary disclosed module, the exemplary disclosed machine learning operations, and/or any other suitable criteria. In at least some exemplary embodiments and for example as described herein, the user may configure system 300 to allow or not allow automatic email export and/or automatic SMS export (e.g., via toggling) for example as illustrated by the exemplary disclosed graphical elements in FIG. 7. Also in at least some exemplary embodiments and for example as described herein, the user may configure system 300 to allow or not allow image queries (e.g., via toggling) for example as illustrated by the exemplary disclosed graphical element in FIG. 10.

At step 415, system 300 may determine whether or not to receive image queries for example based on user input (e.g., via the graphical element illustrated in FIG. 10) and/or any other exemplary disclosed criteria. If system 300 is not configured to enable image queries, process 400 may proceed to step 420.

At step 420, system 300 may receive one query (e.g., a first query). For example as illustrated in FIGS. 5 and 6, user 305 (e.g., and/or users 305a, 305b, and/or 305c) may provide a voice query to system 300 via glasses 310, headphones 315, and/or user device 320. The first query may be a query for an audio and/or text response from system 300 (e.g., may not include a query for an image to be provided). For example, the user may provide a voice query requesting for system 300 to provide keywords for a particular topic of interest.

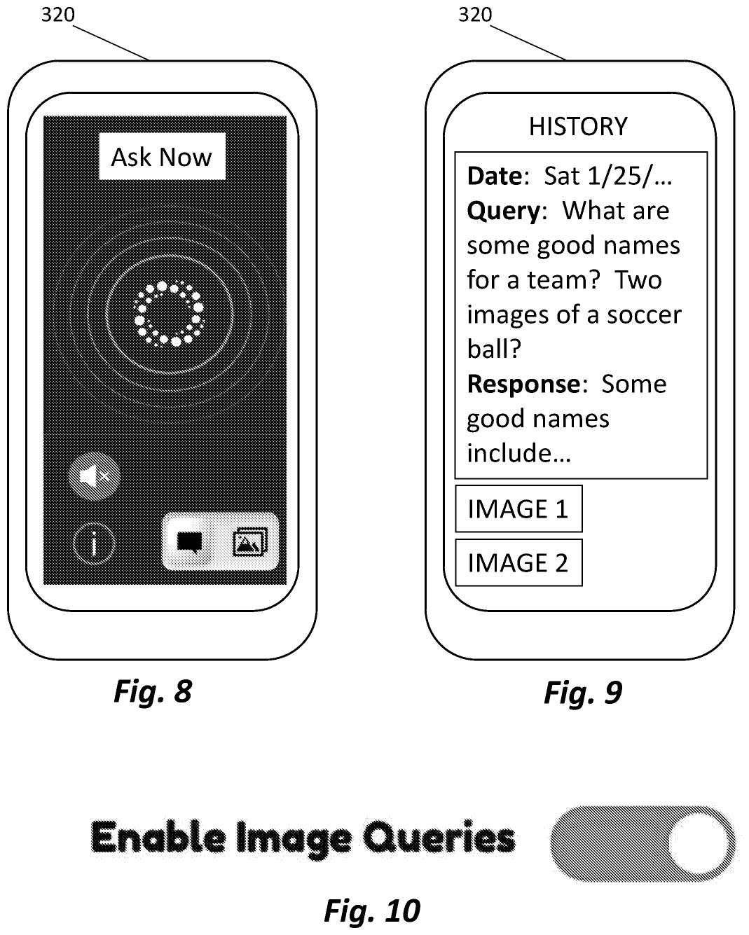

If system 300 is configured to enable image queries at steps 410 and 415, process 400 may proceed to step 425. For example as illustrated in FIGS. 8 and 9, user 305 (e.g., and/or users 305a, 305b, and/or 305c) may provide multiple voice queries to system 300 via glasses 310, headphones 315, and/or user device 320. The first query may be similar to as described above regarding step 420 and may be a query for an audio and/or text response from system 300 (e.g., may not include a query for an image to be provided). The user may also provide a second query that may be a query for one or more images. For example, the second query may be a query for system 300 to provide images associated with a particular topic of interest (e.g., that may be related to the first query).

Following step 420 or step 425, process 400 may proceed to step 430. For example, after a predetermined time period (e.g., 3 seconds), system 300 may end a receiving period for voice (e.g., speech) queries and continue process 400. In at least some exemplary embodiments, steps 415 and 430 may occur simultaneously. At step 430, system 300 may determine whether or not user device 320 (e.g., and/or glasses 310 and/or headphones 315) is locked. For example, user device 320 may be locked when its home screen is turned off for example when being carried in a user's pocket. Also for example, user device 320 may be unlocked when a user has activated user device 320 and user device 320 is displaying a graphical user interface to the user (e.g., for example as illustrated in FIGS. 5-10). If the exemplary disclosed device (e.g., user device 320) is in a locked mode, process 400 may proceed to step 435 as described below. If the exemplary disclosed device (e.g., user device 320) is in an unlocked mode, process 400 may proceed to step 440 as described below. For example, the exemplary disclosed user device (e.g., glasses 310, headphones 315, and/or user device 320) may receive voice queries differently depending on whether the exemplary disclosed device is locked or unlocked.

At step 435, system 300 may receive the first query (e.g., described regarding step 420) or the first and second queries (e.g., described regarding step 425) in a locked mode. For example when the exemplary disclosed user device (e.g., glasses 310, headphones 315, and/or user device 320) is locked, is in the user's pocket, is in a sleep mode, and/or is in any other suitable locked state, the user may activate audio assistant 330 directly on the device via a spoken command, password, user interface (e.g., button), and/or any other suitable technique for activating a voice assistant. The user may then provide the queries for example as described above regarding steps 420 or 425.

At step 440, system 300 may receive the first query (e.g., described regarding step 420) or the first and second queries (e.g., described regarding step 425) in an unlocked mode. For example when the exemplary disclosed user device (e.g., glasses 310, headphones 315, and/or user device 320) is unlocked, displaying the exemplary disclosed graphical user interface to the user, and/or in any other suitable unlocked state, the user may view the interface (e.g., which may indicate that system 300 is waiting for a query). In at least some exemplary embodiments, a user may temporarily mute audio input on a home screen of the exemplary disclosed device via a graphical element (e.g. mute button), which may negate some or all voice input until toggled off. The user may thereby provide voice queries to system 300 directly (e.g., to chatbot platform 335 directly), without use of audio assistant 330. System 300 may also provide audio responses to the user (e.g., as described herein) directly, for example without use of audio assistant 330. In at least some exemplary embodiments, after vocalizing a response to the user as described herein, the graphical user interface (e.g., the screen) may return to a “listening” state for the next query from the user. In at least some exemplary embodiments and as illustrated in FIGS. 5 and 8, one or more graphical elements (e.g., concentric rings around a logo) may be animated with a ripple-like effect (e.g., colored blue when waiting for input, red when receiving voice input from the user, green when voice input is completed, staying green when the app is processing and vocalizing a response, returning to blue when back to waiting, and/or any other desired colors or actions). The user may provide queries for example as described above regarding steps 420 or 425.

Following step 435 or step 440, process 400 may proceed to step 445. At step 445, audio assistant 330 may receive voice data and/or signals and convert the voice data and/or signals to text data and/or signals at step 450 as shown at 340 and 345 of FIG. 4 (e.g., and/or system 300 may directly receive and convert data into text data and/or signals for example as described regarding step 440). At step 455 and as shown at 350 of FIG. 4, chatbot platform 335 may receive the text data and/or signals. Chatbot platform 335 may include a platform, interface, software, and/or hardware for communicating with, prioritizing, and/or selecting a plurality of chatbots of any suitable type for example as described herein.

At step 460, chatbot platform 335 may select one or more chatbots for responding to the received text data and/or signals of the one or more user queries and/or prioritize responses from the one or more chatbots. For example, chatbot platform 335 may select, prioritize, combine, analyze, integrate, process, and/or utilize response text data and/or signals from any desired number of suitable chatbots (e.g., chatbot types) for example as described herein. In at least some exemplary embodiments, multiple chatbots (e.g., including ChatGPT and/or any other suitable chatbots for example as described herein) may be integrated and queried at one time by chatbot platform 335 and results may be presented by voice or text in long or short form and prioritized based on settings, predetermined algorithms, user input, machine learning operations, and/or any other suitable criteria for example as described herein. Response information or any desired length may be presented to users. For example, multiple chatbots may be integrated and queried at one time. Predetermined algorithms, machine learning operations, user input and/or criteria (e.g., user input regarding desired length of responses and desired chatbots), and/or any other suitable criteria may be used for selecting, prioritizing, analyzing, integrating, and/or utilizing a plurality of chatbots to provide a response to each user inquiry. If image data is queried, any suitable image-based artificial intelligence such as, for example, DALL-E and/or any other suitable source may be used. For example, system 300 may operate to provide a suitable amount and/or depth of information to be provided to users based on the exemplary disclosed processing. For example, a desired number (e.g., a maximum number and/or a desired range) of words for a response may be provided by a user (e.g., user input provided by a user), based on a predetermined operation or algorithm of the exemplary disclosed module, based on the exemplary disclosed machine learning operations, and/or any other suitable criteria or technique. For example, a suitable amount and/or depth of information may be set based on the exemplary disclosed settings (e.g., as a part of configuring the exemplary disclosed system and/or settings at step 410). Any desired criteria may be used to determine a suitable amount and/or depth of information (e.g., as a part of configuring the exemplary disclosed system and/or settings at step 410) such as, for example, number and/or type of chatbot, minimum and/or maximum word or character count for the response, summarization criteria (e.g., abstract, executive summary, one-line summary, and/or any other desired level of detail or specificity), and/or any other desired criteria determining amount and/or depth of information. For example, chatbots that users would like to be used in the exemplary disclosed process (e.g., chatbot selection) may be provided as a part of configuring the exemplary disclosed system and/or settings at step 410. In at least some exemplary embodiments, chatbot platform 335 may operate to select, prioritize, integrate, and/or analyze information to be provided to a user via audio, text (e.g., via text and/or email), image, and/or any other suitable technique. Chatbot platform 335 may determine and/or finalize information to be provided to users that may be drawn from and/or integrated from any desired number of different chatbots that may be included in and/or in communication with chatbot platform 335.

At step 465, system 300 may determine whether additional and/or different response information and/or chatbots are to be utilized, whether a prioritization of use of chatbots for providing responses is to be changed, and/or any other adjustment or revision is to be made to responses to user inquiries. If any change or adjustment is to be made, process 400 proceeds to step 470, at which system 470 may operate similarly to as described above regarding step 460. Steps 465 and 470 may be repeated for any suitable number of iterations If no change or no further change is to be made, process 400 may proceed to step 475.

At step 475, system 300 may finalize text and/or image response data and/or signals to be provided to a user in response to one or more user inquiries received by system 300 at step 420 or 425. At step 480, system 300 may determine whether or not image data (e.g., as described at steps 415 and 425 and regarding FIG. 10) and/or for example email, SMS, and/or text data (e.g., as described regarding FIG. 7) is to be provided. If such response data is to be provided (e.g., based on settings and/or configuration at step 410), process 400 may proceed to step 485. If such response data is not to be provided, process 400 may proceed to step 490.

In at least some exemplary embodiments at step 485, an email and/or SMS number that may be provided at step 410 may be utilized. Textual response data may be automatically exported to a specified email or as a text message to an indicated phone (e.g., including any images added by an image generation feature for example as described herein). Such data may also be added to history data and displayed as desired by users for example as illustrated in FIGS. 6 and 9 (e.g., these exports may include date and timestamp information). A user may thereby be allowed to conduct desired (e.g., extensive) research using voice queries, which may for example be shared automatically with the user's account and/or other users (e.g., a team) via a forwarding email and/or SMS, and/or maintained as a record using the exemplary disclosed modules (e.g., application).

Also in at least some exemplary embodiments at step 485, AI-generated images may be added to textual output from system 300, which may be stored by system 300 (e.g., in the application's history and exportable to email and/or SMS alongside a textual response). Image queries may be made via voice assistant (e.g., audio assistant 330) and/or visual interface for example as described at steps 415 through 440. System 300 may operate to generate graphs, charts, detail images, and/or any other desired image data based on a user's voice queries and commands (e.g., and or artificial intelligence operations), which may add visual information to textual responses provided by chatbot platform 335. For example if an automatic response export is enabled (e.g., as illustrated in FIG. 7), requested images may be included in the exported email or SMS of a response as email attachments, a separate SMS photo message, and/or any other suitable technique. A user may query for images in the visual interface using a voice (e.g., speech) query and/or image toggle on the exemplary disclosed graphical user interface.

Further in at least some exemplary embodiments at step 485, based on a user utilizing the exemplary disclosed voice assistant (e.g., audio assistant 330), a user may initiate a query for example as described at steps 420 and 425 (e.g., in response to system 300 stating “If you want to add images, describe them now or say no images” or any other suitable prompt). For example if the user says “no images,” system 300 may respond with textual response vocalization (e.g., based on a query for example as described at step 420). If a user describes one or more images (e.g., as described at step 425), audio assistant 330 may transcribe and communicate this vocal image query (e.g., the exemplary disclosed second query) separately from the linguistic query (e.g., the exemplary disclosed first query) to the exemplary disclosed one or more modules of system 300 for processing (which may in turn submit the transcribed text of the vocal image query to an AI image generator). The returned one or more images in the response from the AI image generator may be placed in the application's history (e.g., in-line at the top of the query's response entry in an app History screen). Also, a second part of the initial query that requested the image (e.g., the second query of step 425) may be added to a query body text in the history (e.g., as illustrated in FIG. 9). By having the one or more images included in (e.g., at a top of) the response, the user may be able to identify (e.g., readily identify) which query entry is which in the history with this visual cue. For example, a user tapping a history entry bubble in the graphical user interface may expand to show full text and also enlarge images if present (e.g., and tapping further on an image may expand the image to full screen with an “X-out” on the top right).

Additionally in at least some exemplary embodiments at step 485, a user may query an image response as a stand-alone query, which may appear in the application history (e.g., as illustrated in FIG. 9). For example if image queries are toggled on in settings of the exemplary disclosed graphical user interface, the user may have the option to toggle what system 300 may retrieve based on the query (e.g., a vocalized text response from system 300, one or more images from an image generator such as DALL-E, and/or other suitable response content). After images are successfully retrieved from the exemplary disclosed image generation AI, system 300 may automatically enter a full screen slideshow of the one or more images (e.g., with an “X-out” for example in the upper right corner). Images may be exportable, for example with a “three-dot menu” below the lower right corner of each image. These images may also be immediately saved to the application history as a response entry for future access. Following step 485, process 400 may proceed to step 490.

At step 490 and as shown at 355 of FIG. 4, audio assistant 330 may receive the exemplary disclosed finalized text data and/or signals from chatbot platform 335. At step 495, audio assistant 330 may convert the finalized text data and/or signals to voice data and/or signals and transfer the voice data and/or signals to the exemplary disclosed device (e.g., glasses 310, headphones 315, and/or user device 320) as shown at 360 of FIG. 4 (e.g., and/or system 300 may directly receive and convert data into voice data and/or signals for example as described regarding step 440). The exemplary disclosed device (e.g., glasses 310, headphones 315, and/or user device 320) may emit sound at step 500 based on the voice data and/or signals for example as shown at 365 of FIG. 4. Images (e.g., if applicable based for example on steps 415 and 425) may be displayed (e.g., including display via GUI and/or augmented reality for example via glasses 310) by the exemplary disclosed device (e.g., glasses 310, headphones 315, and/or user device 320) to the user at step 505 (e.g., similar to display as described above regarding step 485). Process 400 may be repeated for any desired number of iterations of queries. If no further queries are provided to system 300, process 400 may end at step 510.

In at least some exemplary embodiments, system 300 may provide a voice-based method of accessing a chatbot's (e.g., ChatGPT's) textual, conversational AI web app via device-level voice assistants such as Siri and Google Voice, or alternatively via an app-native pathway to the chatbot API (e.g., ChatGPT API). System 300 may make text-only (e.g., text-based) chatbots voice-accessible and therefore usable during tasks which occupy a user's hands and/or visual attention, as well as allowing such chatbots to be used more easily by individuals with visual or motor limitations. System 300 may operate with a device-level voice assistant directly on a smart device (e.g., smartphone), and also operate using a device-level voice assistant through a wearable device such as headphones or smart glasses. Additionally, a user may be able to access conversational AI functionality directly within the exemplary disclosed application (e.g., of the exemplary disclosed modules) without engaging a voice assistant (e.g., for users who dislike Siri). The exemplary disclosed voice assistant access method may function when a user's device (e.g., smartphone or tablet) is locked.

In at least some exemplary embodiments, the exemplary disclosed graphical user interface (e.g., of the exemplary disclosed application of the exemplary disclosed modules) may include a plurality of screens (e.g., splash screen, login/account creation, home screen, query history, settings, billing history screen, and/or any other suitable screens). The exemplary disclosed application may allow a user to speak to chatbot platform 335 instead of typing into it, via an audio assistant when the app is closed and the device is locked, or through the app home screen when opened. The exemplary disclosed application may respond with a text-to-speech vocalization of a textual response of chatbot platform 335. The exemplary disclosed application may include a settings panel allowing a user to login, logout, restore purchase, and toggle between dark and light modes (e.g., dark mode may be a default, and light mode may vary a background color of home screen, history, and settings panel to a desired color such as white). The user may also edit login email and password. The user may also restart and cancel subscription and view billing history using the application. The exemplary disclosed application may provide for the creation of custom voice command integrations for the exemplary disclosed audio assistant for the first access method, and a separate text-to-speech engine for when the application is used without audio assistant.

In at least some exemplary embodiments, the exemplary disclosed graphical user interface (e.g., of the exemplary disclosed application of the exemplary disclosed modules) may include a history that may allow users to access their previous queries and responses in audio and/or text format, and share their results externally. The exemplary disclosed application may allow the user to access their recent queries (e.g., last ten queries) and/or responses via a History tab in a menu drawer of the application. The queries may be in a scrollable list of entry bubbles, labeled with a timestamp of the query and the title (e.g., and the textual query followed by the first few lines of text of the response from chatbot platform 335). Tapping anywhere in the query line item may expand the line item to show the full text of the response (e.g., and the full query in the case where a query is so long it takes up the entire collapsed line item). A double up-arrow indicating collapsing the line item may collapse it back when pressed with a smooth animation. Each query entry in the history may have a speaker button which, when pressed, provides a replay of the entire exchange (e.g., the user's voice query immediately followed by the text-to-speech response from system 300). Tapping the speaker again during the readout may cancel the readout. Each query entry may also have a three-dot style menu that allows the user to delete the item from the history and/or to share using the device share menu. The export may include the query and response text.

In at least some exemplary embodiments, the exemplary disclosed system may be configured to communicate with a chatbot application and may include at least one smart device, comprising a processor, the at least one smart device configured to communicate with the chatbot application that includes computer-executable code stored in non-volatile memory. The at least one smart device may be configured to record a first audio data or signal associated with at least one voice query, and provide the first audio data or signal associated with the at least one voice query to the chatbot application, the chatbot application configured to convert the first audio data or signal to a first text data or signal associated with the at least one voice query. The chatbot application may be configured to operate or communicate with a plurality of chatbots and to select at least one chatbot from the plurality of chatbots based on the first text data or signal. The chatbot application may be configured to generate a second text data or signal associated with a response to the at least one voice query based on operating or communicating with the at least one chatbot. The chatbot application may be configured to convert the second text data or signal to a second voice data or signal associated with the response, and provide the second voice data or signal to the at least one smart device. The at least one smart device may be configured to emit sound based on the second voice data or signal. The at least one smart device may include a pair of smart glasses configured to be paired with a computing device. The at least one chatbot may be ChatGPT. The at least one smart device may be at least one selected from the group of a pair of smart glasses, a pair of headphones, a smartphone, a smart tablet, a computer, a wearable smart device, and combinations thereof. The plurality of chatbots may be a plurality of text-only chatbots that each lack an audio interface. Selecting the at least one chatbot from the plurality of chatbots may include selecting and using multiple chatbots from the plurality of chatbots. Selecting and using the multiple chatbots may include prioritizing the multiple chatbots for use and integrating responses to the at least one voice query of the multiple chatbots based on the prioritizing. Selecting and using the multiple chatbots may include selecting based on using machine learning operations. Selecting the at least one chatbot from the plurality of chatbots may include varying an amount of information of the second text data or signal associated with the response to the at least one voice query. The at least one voice query may include a first voice query requesting an audio response and a second voice query requesting an image response having at least one image. At least one of the at least one smart device or the chatbot application may be configured to transfer the second text data or signal to at least one selected from the group of a third party device via email, the third party device via SMS, and combinations thereof. Converting the first audio data or signal to the first text data or signal may include using an audio assistant of the at least one smart device when the at least one smart device is locked by a user. Converting the first audio data or signal to the first text data or signal may include using a graphical user interface displayed to a user by the at least one smart device without using an audio assistant of the at least one smart device.

In at least some exemplary embodiments, the exemplary disclosed method may be a method for using at least one smart device configured to communicate with a chatbot application. The method may include providing the at least one smart device, comprising a processor, configured to communicate with the chatbot application that includes computer-executable code stored in non-volatile memory, recording a first audio data or signal associated with at least one voice query, and providing the first audio data or signal associated with the at least one voice query to the chatbot application, the chatbot application configured to convert the first audio data or signal to a first text data or signal associated with the at least one voice query. The chatbot application may be configured to operate or communicate with a plurality of chatbots and to select at least one chatbot from the plurality of chatbots based on the first text data or signal. The chatbot application may be configured to generate a second text data or signal associated with a response to the at least one voice query based on operating or communicating with the at least one chatbot. The chatbot application may be configured to convert the second text data or signal to a second voice data or signal associated with the response, and provide the second voice data or signal to the at least one smart device. The method may include emitting sound based on the second voice data or signal. The at least one smart device may include a pair of smart glasses configured to be paired with at least one device selected from the group of a smartphone, a smart tablet, a computer, a wearable smart device, and combinations thereof. The at least one chatbot may be ChatGPT. Selecting the at least one chatbot from the plurality of chatbots may include selecting and using multiple chatbots from the plurality of chatbots based on using machine learning operations, prioritizing the multiple chatbots for use and integrating responses to the at least one voice query of the multiple chatbots based on the prioritizing, and varying an amount of information of the second text data or signal associated with the response to the at least one voice query.

In at least some exemplary embodiments, the exemplary disclosed system may be configured to communicate with a chatbot application. The exemplary disclosed system may include at least one paired device, comprising a processor, the at least one paired device configured to communicate with the chatbot application that includes computer-executable code stored in non-volatile memory. The at least one paired device may be configured to record a first audio data or signal associated with at least one voice query, and provide the first audio data or signal associated with the at least one voice query to the chatbot application, the chatbot application configured to convert the first audio data or signal to a first text data or signal associated with the at least one voice query. The chatbot application may be configured to operate or communicate with a plurality of chatbots and to select at least one chatbot, including at least ChatGPT, from the plurality of chatbots based on the first text data or signal. The chatbot application may be configured to generate a second text data or signal associated with a response to the at least one voice query based on operating or communicating with the at least one chatbot including at least ChatGPT. The chatbot application may be configured to convert the second text data or signal to a second voice data or signal associated with the response, and provide the second voice data or signal to the at least one paired device. The at least one paired device may be configured to emit sound based on the second voice data or signal. The at least one paired device may include a first device that is a pair of smart glasses configured to be paired with a second device. The plurality of chatbots may further include at least one additional text-only chatbot. Generating the second text data or signal associated with the response to the at least one voice query may include using ChatGPT and the at least one additional text-only chatbot. Generating the second text data or signal may include prioritizing ChatGPT and the at least one additional text-only chatbot for use and integrating responses to the at least one voice query of ChatGPT and the at least one additional text-only chatbot based on the prioritizing, and varying an amount of information of the second text data or signal associated with the response to the at least one voice query.

The exemplary disclosed system, apparatus, and method may provide an efficient and effective technique for providing a voice interface function to one or more chatbots that lack a voice interface function. For example, the exemplary disclosed system, apparatus, and method may provide an efficient and effective technique for prioritizing between different chatbots based on using a voice interface function. The exemplary disclosed system, apparatus, and method may also provide a technique for interacting with one or more text-based chatbots lacking a voice interface function.

In at least some exemplary embodiments, the exemplary disclosed system, apparatus, and method may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

An illustrative representation of a computing device appropriate for use with embodiments of the system of the present disclosure is shown in FIG. 12. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, touch boards, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 13, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 13, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 13, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on-any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

It will be apparent to those skilled in the art that various modifications and variations can be made to the disclosed system and method. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. A system configured to communicate with a chatbot application, comprising:
at least one smart device, comprising a processor, the at least one smart device configured to communicate with the chatbot application that includes computer-executable code stored in non-volatile memory;
wherein the at least one smart device is configured to:
record a first audio data or signal associated with at least one voice query;
provide the first audio data or signal associated with the at least one voice query to the chatbot application, the chatbot application configured to convert the first audio data or signal to a first text data or signal associated with the at least one voice query;
wherein the chatbot application is configured to operate or communicate with a plurality of chatbots and to select at least one chatbot from the plurality of chatbots based on the first text data or signal;
wherein the chatbot application is configured to generate a second text data or signal associated with a response to the at least one voice query based on operating or communicating with the at least one chatbot;
wherein the chatbot application is configured to convert the second text data or signal to a second voice data or signal associated with the response, and provide the second voice data or signal to the at least one smart device; and
emit sound based on the second voice data or signal.

2. The system of claim 1, wherein the at least one smart device includes a pair of smart glasses configured to be paired with a computing device.

3. The system of claim 1, wherein the at least one chatbot is ChatGPT.

4. The system of claim 1, wherein the at least one smart device is at least one selected from the group of a pair of smart glasses, a pair of headphones, a smartphone, a smart tablet, a computer, a wearable smart device, and combinations thereof.

5. The system of claim 1, wherein the plurality of chatbots is a plurality of text-only chatbots that each lack an audio interface.

6. The system of claim 1, wherein selecting the at least one chatbot from the plurality of chatbots includes selecting and using multiple chatbots from the plurality of chatbots.

7. The system of claim 6, wherein selecting and using the multiple chatbots includes prioritizing the multiple chatbots for use and integrating responses to the at least one voice query of the multiple chatbots based on the prioritizing.

8. The system of claim 6, wherein selecting and using the multiple chatbots includes selecting based on using machine learning operations.

9. The system of claim 6, wherein selecting the at least one chatbot from the plurality of chatbots includes varying an amount of information of the second text data or signal associated with the response to the at least one voice query.

10. The system of claim 1, wherein the at least one voice query includes a first voice query requesting an audio response and a second voice query requesting an image response having at least one image.

11. The system of claim 1, wherein at least one of the at least one smart device or the chatbot application is configured to transfer the second text data or signal to at least one selected from the group of a third party device via email, the third party device via SMS, and combinations thereof.

12. The system of claim 1, wherein converting the first audio data or signal to the first text data or signal includes using an audio assistant of the at least one smart device when the at least one smart device is locked by a user.

13. The system of claim 1, wherein converting the first audio data or signal to the first text data or signal includes using a graphical user interface displayed to a user by the at least one smart device without using an audio assistant of the at least one smart device.

14. A method for using at least one smart device configured to communicate with a chatbot application, comprising:
providing the at least one smart device, comprising a processor, configured to communicate with the chatbot application that includes computer-executable code stored in non-volatile memory;
recording a first audio data or signal associated with at least one voice query;
providing the first audio data or signal associated with the at least one voice query to the chatbot application, the chatbot application configured to convert the first audio data or signal to a first text data or signal associated with the at least one voice query;
wherein the chatbot application is configured to operate or communicate with a plurality of chatbots and to select at least one chatbot from the plurality of chatbots based on the first text data or signal;
wherein the chatbot application is configured to generate a second text data or signal associated with a response to the at least one voice query based on operating or communicating with the at least one chatbot;
wherein the chatbot application is configured to convert the second text data or signal to a second voice data or signal associated with the response, and provide the second voice data or signal to the at least one smart device; and
emitting sound based on the second voice data or signal.

15. The method of claim 14, wherein the at least one smart device includes a pair of smart glasses configured to be paired with at least one device selected from the group of a smartphone, a smart tablet, a computer, a wearable smart device, and combinations thereof.

16. The method of claim 14, wherein the at least one chatbot is ChatGPT.

17. The method of claim 14, wherein selecting the at least one chatbot from the plurality of chatbots includes:
selecting and using multiple chatbots from the plurality of chatbots based on using machine learning operations;
prioritizing the multiple chatbots for use and integrating responses to the at least one voice query of the multiple chatbots based on the prioritizing; and
varying an amount of information of the second text data or signal associated with the response to the at least one voice query.

18. A system configured to communicate with a chatbot application, comprising:
at least one paired device, comprising a processor, the at least one paired device configured to communicate with the chatbot application that includes computer-executable code stored in non-volatile memory;
wherein the at least one paired device is configured to:
record a first audio data or signal associated with at least one voice query;
provide the first audio data or signal associated with the at least one voice query to the chatbot application, the chatbot application configured to convert the first audio data or signal to a first text data or signal associated with the at least one voice query;
wherein the chatbot application is configured to operate or communicate with a plurality of chatbots and to select at least one chatbot, including at least ChatGPT, from the plurality of chatbots based on the first text data or signal;
wherein the chatbot application is configured to generate a second text data or signal associated with a response to the at least one voice query based on operating or communicating with the at least one chatbot including at least ChatGPT;
wherein the chatbot application is configured to convert the second text data or signal to a second voice data or signal associated with the response, and provide the second voice data or signal to the at least one paired device; and
emit sound based on the second voice data or signal;
wherein the at least one paired device includes a first device that is a pair of smart glasses configured to be paired with a second device.

19. The system of claim 18, wherein:
the plurality of chatbots further includes at least one additional text-only chatbot; and
generating the second text data or signal associated with the response to the at least one voice query includes using ChatGPT and the at least one additional text-only chatbot.

20. The system of claim 19, wherein generating the second text data or signal includes:
prioritizing ChatGPT and the at least one additional text-only chatbot for use and integrating responses to the at least one voice query of ChatGPT and the at least one additional text-only chatbot based on the prioritizing; and
varying an amount of information of the second text data or signal associated with the response to the at least one voice query.
